(19) United States
(12) Patent Application Publication
(10) Pub. No.: US 2014/0325343 A1
(43) Pub. Date: Oct. 30, 2014

(54) Systems and methods for processing web page data

(71) Applicant: Adinfinity Holdings Pty Ltd as Trustee for Adinfinity IP Trust, Paddington (AU)

(72) Inventor: Kartik Rao, Paddington (AU)

(21) Appl. No.: 14/363,555

(22) PCT Filed: Dec. 7, 2012
(86) PCT No.: PCT/AU2012/001482

§ 371 Date: Jun. 6, 2014

(30) Foreign Application Priority Data
Dec. 7, 2011 (AU) 2011905095

(51) Int. Cl. G06F 17/22

(52) U.S. Cl. CPC G06F 17/2247
USPC 715/234

(57) ABSTRACT

Described herein are systems and methods for processing web page data. In overview, these make use of a downloadable API thereby to allow client-side processing of web page data (for example HTML data) in a manner that facilitates efficient generation of a web page, with the capability to execute scripts (such as scripts relating to advertising content) following the generation of a complete Document Object Model (DOM). In overview, placeholders are defined during the generation of the DOM, these serving as containers for results of post-content execution of scripts. In terms of such post-content execution, scripts may be executed in a variety of manners, including immediately following completion of the DOM, at specified times (for example periodic execution thereby to refresh the content of a placeholder at defined intervals), or based on observed conditions (for example enabling execution of scripts in response to their placeholder being on-screen, or in anticipation of that placeholder being on-screen). Although the present embodiments are defined primarily by reference to the execution of scripts, it should be appreciated that the present methodologies are also applicable to execution of other artifacts following the generation of a DOM.

### FIELD OF THE INVENTION

The present invention relates to systems and methods for processing web page data. Embodiments of the invention have been particularly developed for providing an efficient approach for displaying advertisements to users of a web page. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

A conventional model for displaying a web page at a client terminal includes download of web page data from a web server to the client terminal. The client terminal then processes that web page data, typically using a web browser application, thereby allow rendering of the web page in the web browser application. This may include the likes obtaining resources, such as images, from remote locations, and the execution of scripts. Whereas actions such as the download of images can occur in parallel under certain conditions, scripts are executed serially. This can result in unwanted delays in web page rendering, for example where a script requires responses from several remote servers prior to completion (which is common in the context of advertisements). Script-caused bottlenecks are hard to avoid, for example due to complications resulting from document.write commands.

There is a need in the art for improved systems and methods for improved systems and methods for processing web page data.

### SUMMARY OF THE INVENTION

It is an object of the present invention to overcome or ameliorate at least one of the disadvantages of the prior art, or to provide a useful alternative.

One embodiment provides a method for processing web page data, the method including:

receiving web page data from a first web server, the web page data being indicative of a web page to be loaded, the web page data including a plurality of scripts having predefined characteristics and a reference to a content management API;

in response to the reference to the content management API, downloading from a second web server code associated with the content management API for client-side execution; and

processing the remaining web page data based on instructions defined in the code associated with the content management API, wherein that processing includes:

(i) identifying a next one of the plurality of scripts in the remaining web page data;

(ii) defining a placeholder object configured to contain an execution result of execution of the identified script;

(iii) selectively delaying execution of the identified script;

(iv) repeating (i) to (iii) for subsequent scripts in the remaining web page data such that a plurality of placeholders are defined, each being associated with a respective one of the plurality of identified scripts;

(v) following completion of processing of the web page data thereby to define a Document Object Model for the web page, executing the plurality of identified scripts for which execution was selectively delayed in accordance with a predefined protocol, thereby to obtain respective script execution results for each of the identified scripts; and

(vi) updating the placeholders based on the execution results of their respective associated scripts.

One embodiment provides a method for enabling processing web page data, the method including:

providing client access to a content management API, such that referencing the content management API in web page data indicative of a web page causes a client terminal to download code indicative of the content management API, thereby to enable the client to perform a method as discussed herein.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2 illustrates a method according to one embodiment.

FIG. 3 illustrates a general IT implementation arrangement used according to various embodiments.

FIG. 4 illustrates script stacks according to one embodiment.

FIG. 5 illustrates a web page according to one embodiment.

FIG. 6 illustrates a method according to one embodiment.

### DETAILED DESCRIPTION

Described herein are systems and methods for processing web page data. In overview, these make use of a downloadable API thereby to allow client-side processing of web page data (for example HTML data) in a manner that facilitates efficient generation of a web page, with the capability to execute scripts (such as scripts relating to advertising content) following the generation of a complete Document Object Model (DOM). In overview, placeholders are defined during the generation of the DOM, these serving as containers for results of post-content execution of scripts. In terms of such post-content execution, scripts may be executed in a variety of manners, including immediately following completion of the DOM, at specified times (for example periodic execution thereby to refresh the content of a placeholder at defined intervals), or based on observed conditions (for example enabling execution of scripts in response to their placeholder being on-screen, or in anticipation of that placeholder being on-screen).

Although the present embodiments are defined primarily by reference to the execution of scripts, it should be appreciated that the present methodologies are also applicable to execution of other artifacts following the generation of a DOM.

### General Framework

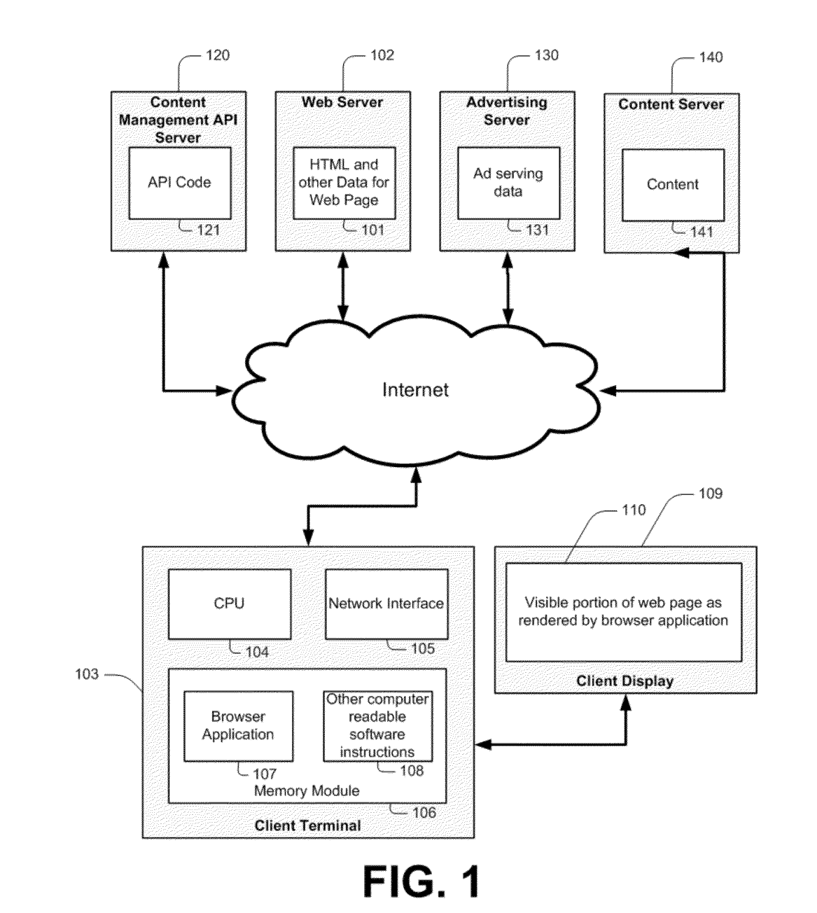

FIG. 1 illustrates a framework according to one embodiment. In overview, a publisher of a web page makes HTML and other website data 101 available via a web server 102. In some cases this data is served via a plurality of distinct servers. The server is accessible via the Internet by a client terminal, such as client terminal 103 (which may be a PC, PDA, tablet, smartphone, other mobile computing device, or the like). Client terminal 103 includes a CPU 104 coupled to a network interface 105 and a memory module 106. Memory module 106 carries software instructions to enable the execution of a web browser application 107 on client terminal 103. Memory module 106 also includes other software instructions 108.

Client terminal 103 is operated thereby to provide via a display 109 a rendering of the web page provided by web server 102 by way of browser application 107. The web page includes a portion that is viewable on-screen, and may additionally include one or more portions that are not viewable on-screen at a given point in time (for example a user might perform a scrolling operation to bring those portions on-screen).

As context, when a user of client terminal 103 wishes to visit the web page hosted by web server 102, the client navigates to an associated address using web browser 107. The web browser 107 then downloads web page data 101, which provides a set of tasks to be performed by web browser 107 thereby to enable rendering of the web page. For example, web page data 101 includes references to resources such as images, which are downloaded from specific locations and positioned in the rendered page at a specified position, and executable scripts.

In the present embodiment, data 101 includes a reference to a content management API, which is made available by an API server 120 (API server may optionally be integrated with a server having additional functionality in the context of FIG. 1; there is no requirement that it be a standalone server). Specifically, the reference is provided within HTML code which directs the web browser application to download from server 120 data indicative of API code 121. The API code 121 is then executed via the client terminal (for example within the context of web browser 107). This may include loading several API modules which load independently and inform one another of progress, thereby to execute a modular API.

In overview, a publisher of a web page, such as the web page based on web page data 101, optionally leverages functionality of the content management API by referencing that API, and including page-specific information in API code thereby to configure the API. For example, the page-specific information may include publisher details, page details, and/or information to assist in the selection of advertisements to be displayed on the web page (such as information concerning the page, identification of advertisement selection/serving services, characteristics of the user viewing the page, and so on).

As the web browser executes web page data 101, it identifies the reference to the API (which is preferably located in a preliminary portion of the HTML code), and downloads the API code such that the API executes client side.

Web page data 101 includes a plurality of top level scripts. Traditionally, these would be executed serially in the order they appear in the web page data. However, the content management API is configured such that it manages certain scripts in a predefined manner. In particular, one functionality of the API is to allow delayed execution of scripts, such that a Document Object Model of the web page is defined prior to execution of those scripts, thereby to result a user perception of quicker page loading times (as the page is loaded and functional without delays for the delayed scripts). This is particularly useful in the case of scripts that call up advertisements, which may be time consuming, for example where multiple servers are involved in the process. For example, calling up an advertisement may involve first involving an advertising server 130 which maintains ad serving data 131 (which enables selection of an advertisement for display), and also a content server 140 which delivers content 141 (such as an image or other data that defines an advertisement to be displayed on the web page); a website can be functionally rendered for a user in the first instance, and the advertisement-calling scripts executed upon that rendering.

The content management API is configured to manage top level scripts having predefined characteristics. Each top level script may include one or more child scripts (including child scripts that are nested beneath other child scripts). In the event that a top level script satisfies the predetermined criteria and is to be managed based on the API, all underlying child scripts are also managed by the API.

In some embodiments the predefined characteristics code included within or associated with the script, which is manually added in a top-level script thereby to inform the API that the script in question is to be managed by the API. A script header may also include instructions as to how the script is to be managed by the API, for example:
An instruction to execute the script in a post-content mode (i.e. upon completion of the DOM).
An instruction to execute the script in response to defined criteria (for example at a predetermined time or in response to the occurrence of a specified event). For example, this may include a visibility mode, whereby a script is executed only where an object that is affected by that script is displayed on-screen, or anticipated to be displayed on-screen within a set timeframe.
An instruction to execute a script on multiple occasions (for example periodically or upon certain activities) in post-content mode. For example, this may allow re-execution of a script thereby to obtain a different advertisement for a web page, without refreshing the web page.
An instruction to execute the scripts in an inline mode (i.e. execution is not delayed for that script).

In the case of scripts that are to be executed upon the occurrence of a specified event (for example upon completion of the DOM), event handlers are used. In particular, the API code provides for one or more event handler modules. In the event that a script is to be executed upon the occurrence of an event, a master event handler module configures an event handler to watch for that event. Upon occurrence of the event, a signal is generated thereby to cause execution of the script. Preferably the event handler ten terminates, which assists in efficient utilisation of memory resources.

Utilisation of code in the script, or associated with the script, to direct the API as to how a particular script should be managed is only one two a number of approaches that the implemented across various embodiments. Other approaches include the use of a separate portion of code which references scripts appearing later in the HTML code, and analysis of scripts themselves thereby to determine whether predefined conditions are met (such as determining whether a script is defined to call up and advertisement from one of a plurality of specified sources).

### Script Management Method

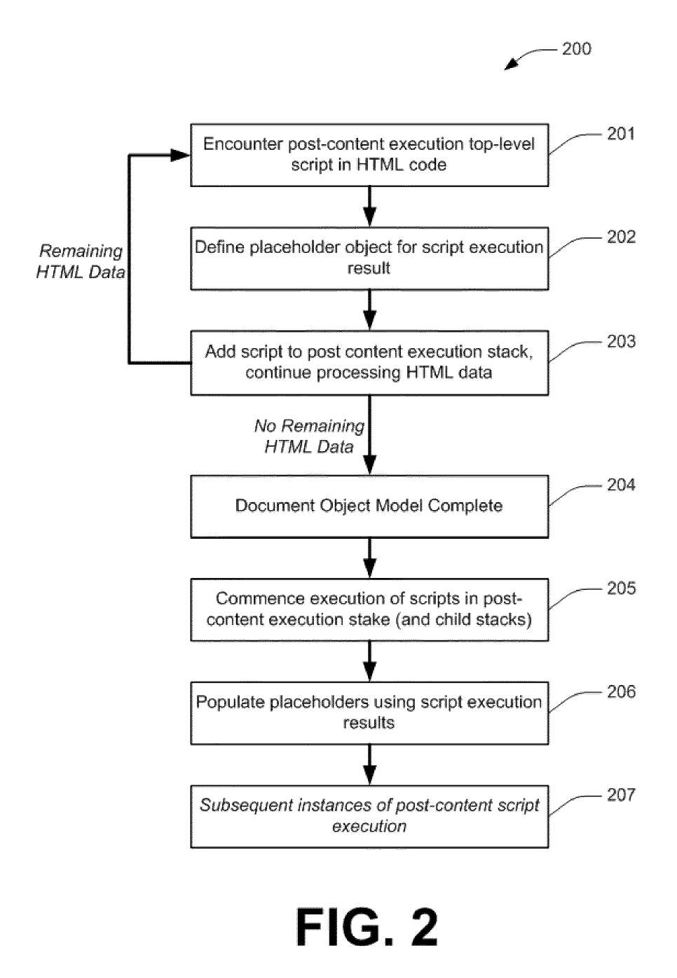

FIG. 2 illustrates an exemplary method 200 for managing web page data using a client-side-executed content management API. Method 200 is performed by web browser application 107. Another embodiment provides a method performed by content management API server 120. For example, that server implements a method including providing client access to a content management API, such that referencing the content management API in web page data indicative of a web page causes a client terminal to download code indicative of the content management API, thereby to enable the client to perform a method such as method 200.

As discussed above, code for such an API is downloaded by a client terminal in response to a reference to the API in web page data for a web page, and configures a browser application to process remaining web page data for that web page based on instructions defined by the API. It will be appreciated that method 200 illustrates only a selection of the steps involved in processing web page data thereby to render a web page, being those steps relevant to management of scripts by the content management API. It will be appreciated that processing the web page data includes other activity, for example downloading and positioning images, and synchronous execution of scripts that are not flagged for post-content execution.

Functional block 201 represents a process including identifying a next one of the plurality of scripts in the remaining web page data, being a top-level script that is to be managed on the basis of the content management API. For example, as discussed above, there may be code in a script header, or immediately preceding the script, thereby to identify the script as being intended to post-content execution.

Functional block 202 represents a process including defining a placeholder object configured containing an execution result of execution of the identified script. The size and/or position for the placeholder object may be determined from analysis of the script, or may be explicitly defined in a manner recognisable by the content management API. The defined object is added to the Document Object Model for the web page. The script itself is added to a post-content execution stack at 203, thereby delaying execution of the identified script. Delaying execution is a selective step, noting that some scripts may be designated for immediate execution (i.e. in inline mode). Such scripts are nevertheless the subjects of placeholders, thereby allowing for additional post-content re-execution, thereby to refresh the content of placeholders post DOM.

In some embodiments a step of configuring one or more event handlers associated with a script/placeholder occurs at functional block 202 or 203. As noted above, the API code provides for the configuration of such event handlers thereby to watch for events in response to which delayed execution scripts are to be executed.

Following functional block 203, method 200 either loops to 201 (if there is web page data remaining, such that a plurality of placeholders are defined, each being associated with a respective one of the plurality of identified scripts) or continues to 204. At 204, all web page data has been processed (although with script execution delayed subject to influence of the post content management API) and the Document Object Model is complete. At this point the web page is functionally rendered from a user perspective.

Following completion of processing of the web page data thereby to define a Document Object Model for the web page at 204, method 200 includes executing the plurality of identified scripts in accordance with a predefined protocol at 205, thereby to obtain respective script execution results for each of the identified scripts. Following this, 206 includes updating the placeholders based on the execution results of their respective associated scripts. For example, each placeholder is provided with a “done” callback, being a JavaScript function that is fired when the associated script and all its children have completed execution.

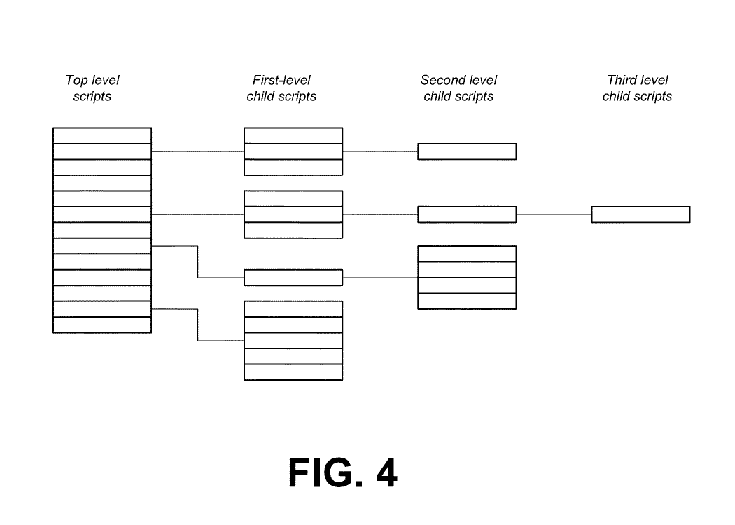

In the context of functional block 205, each top level script is placed in a parent stack for the purposes of delayed execution, and each top level script in the parent stack is configured to create a respective child stack to manage its associated one or more child scripts. The parent stack and child stacks are defined in a FIFO (First In First Out) stack type; from a data structure perspective this is “a stack that contains many stacks”, and as such FIFO is used to maintain order. An example of the parent/child stack data structure according to one embodiment is provided in FIG. 4, which illustrates a top level (patent) stack, and various scripts within that stack having child stacks, with some of those child stacks having their own child stacks, and so on.

Functional block 205 includes initially moving through the parent stack, commencing evaluation of evaluating the scripts in order. In some embodiments closures are used thereby to wrap execution of a script in a separate context, and hence separate scripts from each other. From that point, the process represented by functional block 206 includes going through the second level child stack and interpreting the child scripts in order. This optionally involves:
Fetching remote scripts via AJAX or script tag injection, but not executing them until they can be analysed.
Wrapping all document.write calls in a context
Creating closures and callbacks to manage contexts
Executing callbacks when a script finishes
Evaluating data in the context of the window so the page can access data that the script is meant to provide.
Adding more children to the stack as and when scripts reference other scripts.

In the context of scripts for calling up advertisements, upon completion of execution of such a script and its children, the script execution result (which may include an image or the like) is placed in the associated placeholder. From a user perspective, this may mean that a web page becomes functional, but spaces reserved for advertising content remain blank pending execution of the relevant scripts. This may be for only a fraction of a second in some cases.

### Post Content Execution of Scripts

As noted above, the content management API is configured to manage post-content execution of scripts both upon completion of the DOM, or at a later point in time. This later execution is represented by functional block 208.

Execution at block 208 may include executing one or more of the scripts upon at a predetermined time completion of the DOM (for example using a time-based trigger, optionally a repeating time-based trigger). In the context of scripts for advertisements, this may be used to refresh/replace advertisements in the placeholder without needing to refresh/interfere with a loaded web page.

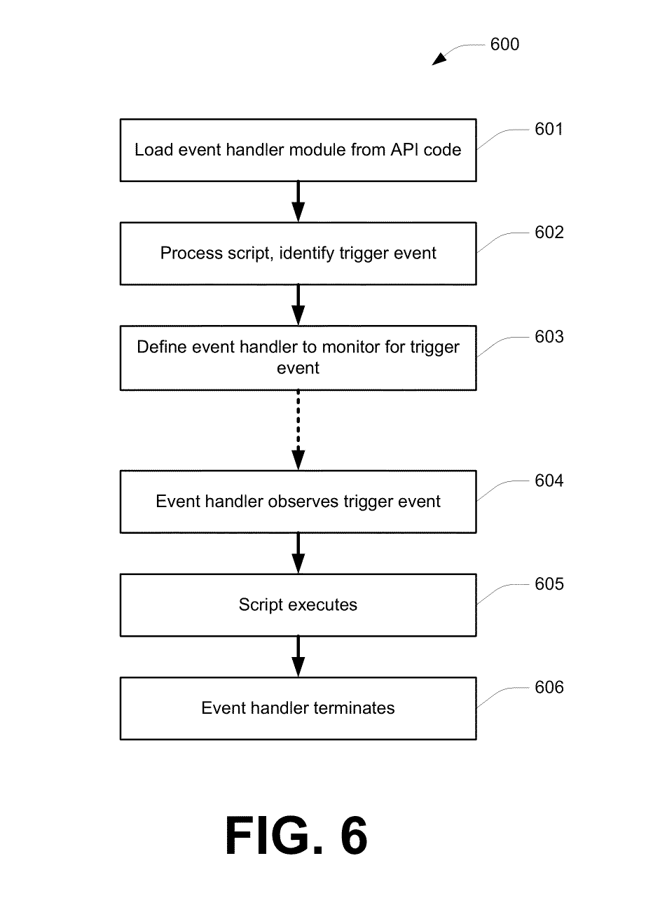

Execution at block 208 may include executing one or more of the scripts in response to the occurrence of specified events, or at predetermined times. As noted adobe, the content management API provides for event handlers to watch for such events, thereby to trigger the execution of scripts post content. In this regard, FIG. 6 illustrates an exemplary method 600 performed by the web browser based on the API code. Functional block 601 includes loading an event handler module from API code. As HTML code is processed, a trigger event is identified for a given script at 602. An event handler is then defined to watch for the relevant trigger event at 603. The event is observed by the event handler at 604, and this triggers execution of the script at 605. The event handler then terminates at 606 (assuming that there it was configured to watch for a one-off event; in some cases an event handler is persistent and a script re-executes each time the event re-occurs).

By way of example, for a given one of the scripts, the specified event may relate to the position of the associated placeholder object relative to an on-screen view of the web page. In some such cases the given one of the scripts is executed in anticipation of the placeholder object becoming viewed on-screen at a client terminal. This example is described in more detail below.

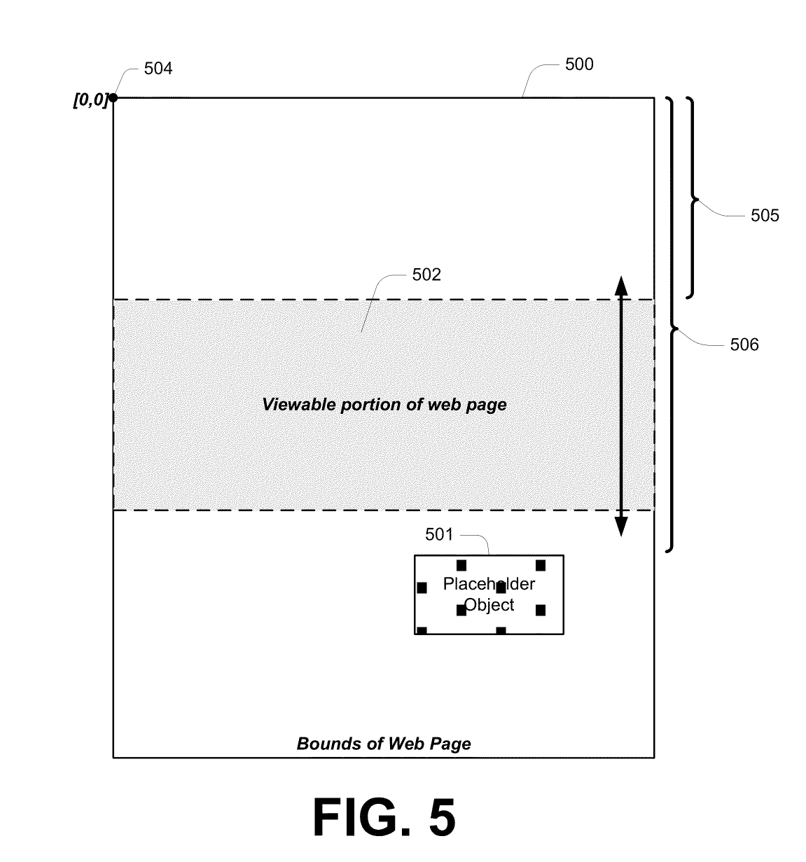

FIG. 5 provides a representation of a rendered web page 500. This web page includes a placeholder object 501, which is defined to contain the execution result of a script (for example an advertisement obtained from an advertising server and/or content server subject to execution of a script). Not all of web page 500 is visible on-screen via a browser application at a client terminal. Only the region underling rectangle 502 is viewable. Scrolling using the web browser moves rectangle 502 relative to page 500, altering the visible portion. The HTML data for page 500 is defined such that the content management API determines that the script associated with object 501 is to be executed in a “visibility mode”, which means that the script is executed in anticipation of object 501 being viewable (i.e. moving into rectangle 502). Such scrolling fires events in the web browser, and the API configures an event handler to monitor those events, thereby to determine when the placeholder object is proximal rectangle 502. For example, a page origin 502 may be used, in conjunction with a viewable bound offset 505 and an object offset 506. For example:
One master event handler module is set on the browser, via the API, that module being notified on “scroll” events.
One internal handler (watcher) that is created for each element that is watched being.
Watcher's are each given a unique id called a HASH.
The master handler goes through all the watchers using the HASH and checks for visibility.
Once an element is visible the master fires the associated callback thereby to execute the script, “unwatches” the element and cleans up any watchers.

A first exemplary calculation algorithm is outlined below:

```
    element refers to the element being tested for visibility
    window refers to the top level window, this is only accessible
    when the content management API is executed within an IFRAME
    that sets document.domain to be the same as that of the parent
    page (Friendly IFRAME) OR the content management API is
    executed within the top level window. In cases where the top level
    window is not accessible the algorithm in alternative two and/or
    three must be used.
    Set TOP = The element's scroll Top property OR the document
    body's scroll Top property
    SET DISTANCE = The view distance at which the event handler
    is triggered, must be a non negative integer
    Set HEIGHT =
    Browser window's innerHeight property OR
    The element's clientHeight property OR
    The document body's clientHeight property
Set VIEW = HEIGHT + TOP
If VIEW >= (element's offsetTop − DISTANCE) THEN VISIBLE ELSE
INVISIBLE
```

A second exemplary algorithm is as follows:

Use DOM JavaScript method : getBoundingClientRect to retrieve position
of the element within the current browser window, extract the elements
TOP position from the co-ordinates returned.
Compare the element's TOP position with the VIEW area to check if the
element in currently visible.

A further exemplary algorithm is as follows:

Create a temporary placeholder element as a sibling of element 501.
Load a flash file (.swf extension) from the same domain as the content
management API into the sibling element created above. The flash file
listens to flash events INIT, ACTIVATE, DEACTIVATE, THROTTLE.
When a flash event is received it calls a javascript function within our
namespace with the event name and details.
When an element is off the currently viewable screen INIT and
THROTTLE events are fired, the details of the THROTTLE event
indicate that rendering has been paused since the flash object is not in
a viewable area.
When an element enters the viewable area another THROTTLE event is
fired, the details of the event indicate that rendering has been resumed
since the object is now viewable. When this event occurs we consider
the element to be viewable and execute and follow on actions

It may also happen that an element may not be visible since the user is on another tab in the browser, this is indicated by ACTIVATE and DEACTIVATE events, THROTTLE events may also be fired depending on the browser being utilized and the flash plugin version used, this is accounted for in the logic that determines if an element is in view.

Further to the above, in some cases a THROTTLE event is not fired at all if the element is off screen initially or if the THROTTLE event is unavailable in the browser and flash plugin version being utilized. To account for these scenarios a javascript timer is started using setInterval, if after a reasonable interval of time a THROTTLE event is not received or if there is a javascript/flash runtime error, the element is assumed to be visible and follow on actions are executed as a fallback.

Other flash events may be watched for as necessary, the timer interval may be adjusted to account for browser inconsistencies and race conditions.

The order of events being fired may be different for different browsers such as between Internet Explorer, Mozilla Firefox and Chrome, this is preferably accounted for in a content management API that detects the browser being used and sets up the visibility detection accordingly.

As a further alternative, the W3C HTML5 standard also provides a page visibility API, where practical this API may also be used to determine if the entire page is invisible thereby avoiding the need to perform calculations/determination at an element level since the entire page is not visible. This is relevant in cases where the user is on another browser tab or the browser has been minimised.

It will be appreciated that a range of other event handling approaches may be used to manage post-content execution of scripts. It will be further appreciated that the API may be modified over time to allow for additional functionalities in that regard—the API code is updated centrally to allow for new forms of event handler, and users informed of how to code web page data thereby to make use of such handlers.

Although there are other technologies in existence that allow for delayed execution of scripts (such as AJAX/Script Defer), these fail and overwrite a page for scripts containing a document.write command. This significantly limits the applicability of such technologies for post content rendering of advertisements, as a document.write command present in almost all script based advertisement, based on current conventions. The technology disclosed herein, on the other hand, is well suited to handle post content rendering of scripts containing document.write commands.

### Template-Based Vendor Independence

In some cases the code of the content management API is configured to streamline the manner by which various vendor-specific functionalities are made available on a web page. These functionalities may include display ad servers, text ad servers, site analytics, market analytics, and behavioural targeting. The API allows a user to select a preferred supported vendor for any of those functionalities via a template, and detailed aspects of page configuration are handled by the API. This allows, by way of example, a page publisher to conveniently use multiple advertisement serving vendors on a single page, or even select an advertisement serving vendor associated with a given object “on-the-fly” based on characteristics of the user viewing the page (for example selecting a vendor based on the location of the user).

### Exemplary System-Level Overview

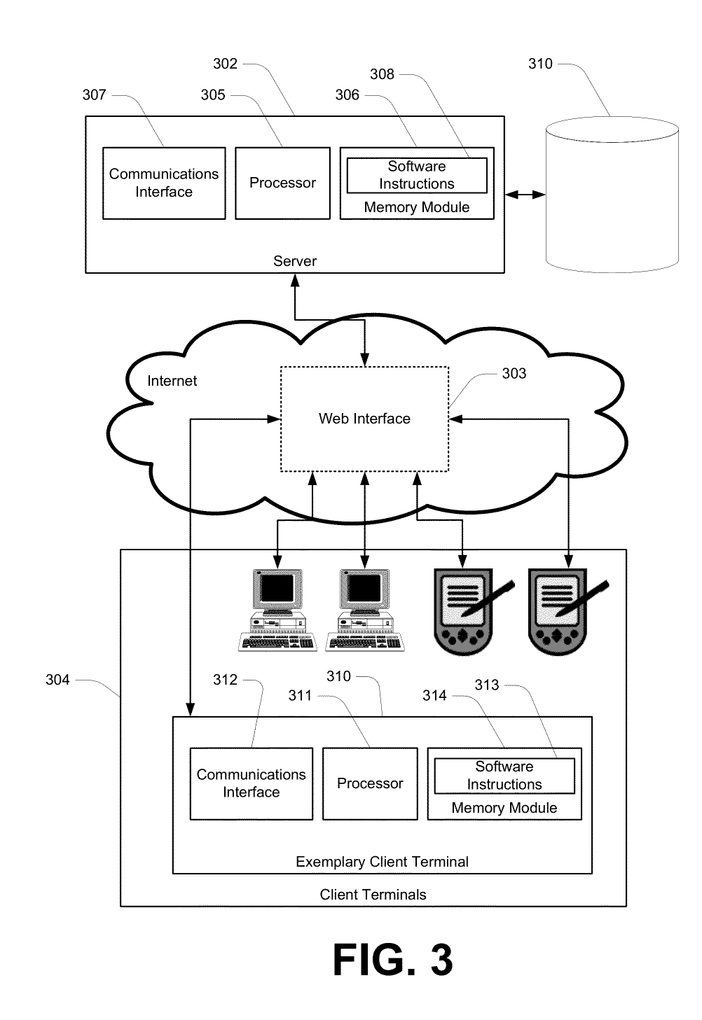

In some embodiments, methods and functionalities considered herein are implemented in the context of a web server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302.

### CONCLUSIONS AND INTERPRETATION

It will be appreciated that the disclosure above provides various significant systems and methods for processing web page data. For example, end users' perceived page load times are improved by a function of the weight and latency of the delayed calls, parts of a page that were AJAX unsafe may now be reloaded on demand without reprocessing entire page. Furthermore, calls for advertisements can be aborted or cancelled if unnecessary in the context of the web page's current state (for example based on advertisement visibility), thereby reducing bandwidth costs (and financial costs in relation to third party vendors who provide advertisements or other dynamic content).

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for processing web page data, the method including:
receiving web page data from a first web server, the web page data being indicative of a web page to be loaded, the web page data including a plurality of scripts having predefined characteristics and a reference to a content management API;
in response to the reference to the content management API, downloading from a second web server code associated with the content management API for client-side execution; and
processing the remaining web page data based on instructions defined in the code associated with the content management API, wherein that processing includes:
(i) identifying a next one of the plurality of scripts in the remaining web page data;
(ii) defining a placeholder object configured to contain an execution result of execution of the identified script;
(iii) selectively delaying execution of the identified script;
(iv) repeating (i) to (iii) for subsequent scripts in the remaining web page data such that a plurality of placeholders are defined, each being associated with a respective one of the plurality of identified scripts;
(v) following completion of processing of the web page data thereby to define a Document Object Model for the web page, executing the plurality of identified scripts for which execution was selectively delayed in accordance with a predefined protocol, thereby to obtain respective script execution results for each of the identified scripts; and
(vi) updating the placeholders based on the execution results of their respective associated scripts.

2. A method according to claim 1 wherein the API is configured to identify whether or not a particular script satisfies the predefined characteristics.

3. A method according to claim 2 wherein a script is determined to have the predefined characteristics in the event that it includes or is associated with code recognisable to the API.

4. A method according to claim 1 wherein the scripts having predefined characteristics are scripts for enabling the presentation of advertisements served by one or more further web servers.

5. A method according to claim 1 wherein the plurality of scripts are top level scripts, and one or more of the top level scripts includes an associated one or more child scripts.

6. A method according to claim 5 wherein each top level script is placed in a parent stack for the purposes of delayed execution, and each top level script in the parent stack is configured to create a respective child stack to manage its associated one or more child scripts.

7. A method according to claim 6 wherein the parent stack and child stacks are defined in a First In First Out (FIFO) stack type.

8. A method according to claim 6 wherein each top level script is provided with a “done” callback that executes upon completion of the top level script and its one or more child scripts.

9. A method according to claim 6 wherein closures are used thereby to wrap execution of each script in a different context.

10. A method according to claim 1 wherein (v) includes executing one or more of the scripts upon completion of the DOM.

11. A method according to claim 1 wherein (v) includes executing one or more of the scripts upon at a predetermined time or upon a specified event following completion of the DOM.

12. A method according to claim 11 wherein a given script is executed on multiple occasions at predetermined times or upon specified events following completion of the DOM.

13. A method according to claim 11 wherein the API is configured to define an event handler for each script, thereby to manage execution of respective script in response to the occurrence of a specified event.

14. A method according to claim 11 wherein for a given one of the scripts, an event in response to which script execution is initiated is defined based on movement of the position of an on-screen view of the web page relative to the placeholder object associated with that script.

15. A method according to claim 14 wherein the given one of the scripts is executed in anticipation of the placeholder object becoming viewed on-screen at a client terminal.

16. A method for enabling processing web page data, the method including:
providing client access to a content management API, such that referencing the content management API in web page data indicative of a web page causes a client terminal to download code indicative of the content management API, thereby to enable the client to perform a method according to claim 1.

17. A computer system configured to perform a method according to claim 1.

18. A computer program configured to perform a method according to claim 1.

19. A non-transitive carrier medium carrying computer executable code that, when executed on a processor, causes the processor to perform a method according to claim 1.

20. (canceled)
